(19) United States
(12) Patent Application Publication
(10) Pub. No.: US 2025/0070128 A1
(43) Pub. Date: Feb. 27, 2025

(54) ASSB Composite Cathode Having a Halide-Based and a Sulfide-Based Material

(71) Applicant: Nissan North America, Inc., Franklin, TN (US)

(72) Inventors: Zongtang Fang, Northville, MI (US); Javier Parrondo, Novi, MI (US); Naoki Ueda, Novi, MI (US); Bharat Gattu, Farmington, MI (US)

(21) Appl. No.: 18/237,509

(22) Filed: Aug. 24, 2023

(51) Int. Cl. H01M 4/36; H01M 4/38; H01M 4/505; H01M 4/525; H01M 4/62; H01M 50/431; H01M 50/46

(52) U.S. Cl. CPC H01M 4/366; H01M 4/382; H01M 4/505; H01M 4/525; H01M 4/625; H01M 50/431; H01M 50/46; H01M 2004/027; H01M 2004/028

(57) ABSTRACT

An all-solid-state battery cell has a lithium metal anode, a cathode current collector, a composite cathode layer, and a separator between the composite cathode layer and the lithium metal anode. The composite cathode layer has active cathode material particles coated in a lithium halide material; and a lithium sulfide material embedding coated active cathode material particles.

### TECHNICAL FIELD

This disclosure relates to all-solid-state batteries (ASSBs) having a composite cathode material comprising active cathode material coated in a lithium halide-based material and mixed with a lithium sulfide-based material.

### BACKGROUND

Advances have been made toward high energy density batteries, using lithium metal as the anode material, and solid electrolytes to form all-solid-state batteries (ASSBs). Discovery of new materials and the relationship between their structure, composition, properties, and performance have advanced the field. However, even with these advances, batteries remain limited by the underlying choice of materials and electrochemistry. Among the components in ASSBs, the cathode active material may limit the energy density and dominate the battery cost.

One of the challenges to the practical application of ASSBs is to increase the cathode material ion conductivity while minimizing side reactions occurring at the interface between the cathode active material and the solid electrolyte.

### SUMMARY

Disclosed herein are implementations of a composite cathode layer for use in an ASSB with a lithium metal battery. The composite cathode layer uses both a lithium halide material and a lithium sulfide material to increase the ionic conductivity of the cathode while reducing the interfacial instability, including mitigating hydrogen sulfide generation.

An implementation disclosed herein is an all-solid-state battery cell that has a lithium metal anode, a cathode current collector, a composite cathode layer, and a separator between the composite cathode layer and the lithium metal anode. The composite cathode layer has active cathode material particles coated in a lithium halide material; and a lithium sulfide material embedding coated active cathode material particles.

Another implementation disclosed herein is a composite cathode layer for an all-solid-state battery cell, consisting, in use, of: active cathode material particles; a lithium halide material coated onto the active cathode material particles; a lithium sulfide material embedding coated active cathode material particles; and, optionally, one or both of carbon and a dry binder interspersed throughout the lithium sulfide material.

Another implementation disclosed herein is an all-solid-state battery cell having a lithium metal anode, a cathode current collector, a composite cathode layer, and a separator between the composite cathode layer and the lithium metal anode. The composite cathode layer consists of, in use: active cathode material particles; a lithium halide material coated onto the active cathode material particles; a lithium sulfide material embedding coated active cathode material particles; and, optionally, one or both of carbon and a dry binder interspersed throughout the lithium sulfide material.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a side view schematic of an ASSB cell having a composite cathode layer as disclosed herein.

FIG. 2 is a side view schematic of the composite cathode layer of the ASSB cell as disclosed herein.

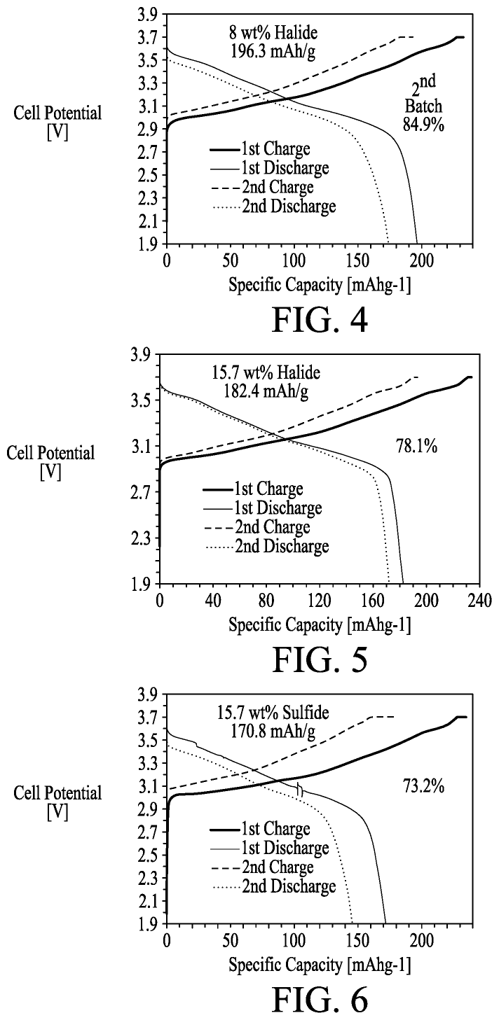

FIGS. 3-6 are charge-discharge curves for test cells A-D in Table 1, respectively.

FIGS. 7-10 are charge-discharge curves for test cells A-D in Table 2, respectively.

### DETAILED DESCRIPTION

Advances have been made toward high energy density batteries, including both lithium metal and lithium-ion batteries. However, these advances are limited by the underlying choice of materials and electrochemistry. Traditional lithium-ion batteries either use organic liquid electrolytes, prone to negative reactions with active materials, or ionic liquid electrolytes, with increased viscosities and lower ionic conductivity. ASSBs can address some or all of these issues, as well as produce higher energy densities. However, the large interfacial resistance at the electrolyte/electrode interface and the interfacial stability and compatibility due to reactivity affect the electrochemical performance of ASSBs.

For ASSBs, electrode materials are those that reversibly insert ions through ion-conductive, crystalline materials. Conventional cathode active material consists of a transition metal oxide with the formula LiMOₓ, where M is one or more transition metals, which undergoes low-volume expansion and contraction during lithiation and delithiation. The anode active material can be lithium metal, the low density of lithium metal producing a much higher specific capacity than traditional graphite anode active material.

With ASSBs, the cathode is a dry cathode, meaning no liquids or gels are present in the as-used battery cell. The cathode active material is often mixed with carbon material to increase electronic conductivity. However, dependent on the cathode active material used, ionic conductivity can still be lacking.

While solid electrolytes show promise with the lithium metal anodes, and solid electrolytes have been developed with high ionic conductivities, the chemical, electrochemical and mechanical stabilities at the cathode active material-solid electrolyte interfaces present challenges. In particular, sulfide solid electrolytes have relatively poor intrinsic chemical and electrochemical stabilities against traditional transition metal oxide cathode materials.

The composite cathodes disclosed herein utilize a combination of a lithium halide material and a lithium sulfide material selected to improve ionic migration, provide a wide electrochemical stability window against lithium, mitigate side reactions with the cathode active material, and reduce hydrogen sulfide production. The composite cathodes herein focus on improving the performance of transition metal oxide-based cathode active materials in ASSBs with lithium metal anodes.

The lithium halide material provides electrochemical stability and does not evolve hydrogen sulfide. However, lithium halide materials are expensive, have a lower conductivity than lithium sulfide materials, and may not be stable with lithium. To take advantage of the electrochemical stability of the lithium halide material, it is coated on the active cathode material particles, forming a protection layer. Lithium sulfide materials are highly conductive and are less costly than lithium halide materials. However, lithium sulfide materials can be unstable with the cathode active material, forming unstable cathode-electrolyte interfaces and producing hydrogen sulfide through side reactions. To take advantage of the high ionic conductivity of the lithium sulfide materials, the lithium sulfide materials are incorporated into the cathode layer with the coated active cathode material. The protection layer reduces or eliminates the electrochemical instability between the lithium sulfide materials and the active cathode materials.

The composite cathodes disclosed herein utilize the lithium halide material as a coating on active cathode material particles. The lithium halide material provides lithium conductivity near the active cathode material particles while functioning as a protective layer, shielding the cathode active material from the bulk lithium sulfide material in which the coated cathode active material is mixed. Side reactions between the lithium sulfide material and the cathode active material are minimized while the lithium-ion conductivity is well established with the lithium sulfide material.

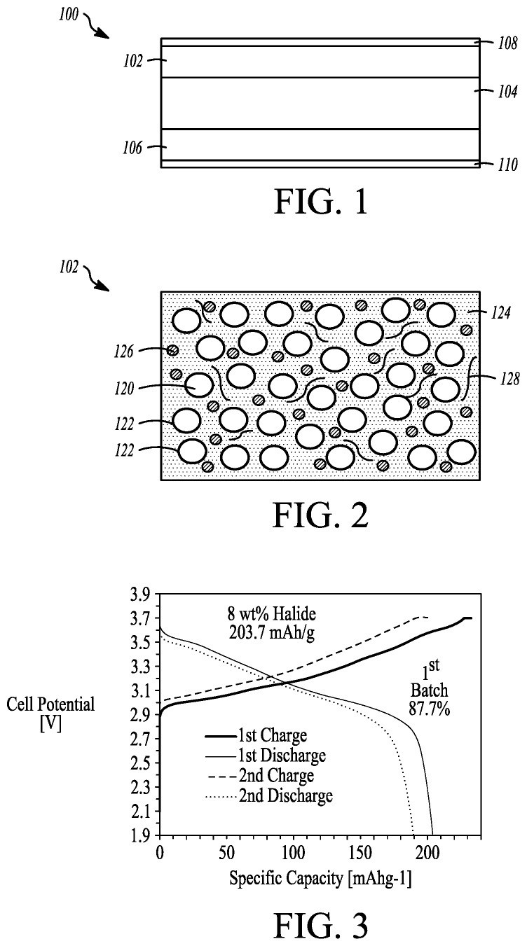

An ASSB cell 100 is illustrated schematically in cross-section in FIG. 1. The ASSB cell 100 of FIG. 1 is configured as a layered battery cell that includes as active layers a composite cathode layer 102 as described herein, a separator 104, and a lithium metal anode 106. In addition to the active layers, the ASSB cell 100 of FIG. 1 may include a cathode current collector 108 and an anode current collector 110, configured such that the active layers are interposed between the anode current collector 110 and the cathode current collector 108. In such a configuration, the cathode current collector 108 is adjacent to the composite cathode layer 102, and the anode current collector 110 is adjacent to the anode active material layer 106. An ASSB can be comprised of multiple ASSB cells 100.

The lithium metal anode 106 can be a layer of elemental lithium metal, a layer of a lithium compound(s) or a layer of doped lithium. The anode current collector 110 can be, as a non-limiting example, a sheet or foil of copper, nickel, a copper-nickel alloy, carbon paper, or graphene paper.

The separator 104 can be, as non-limiting examples, highly ion conductive sulfide compounds (e.g., Argyrodite-type such as Li₆PS₅Cl, LGPS, LPS, etc.). The separator 104 may also be one of Li₆PS₅Cl, Li₆PS₅Br, Li₆PS₅I, Li₆PSsClₓBr₁₋ₓ (0.2<x<0.8), Li₇₋ₓPS₆₋ₓClₓ (x=1.1-1.9), or Li₇₋ₓPS₆₋ₓBrₓ (x=1.0-1.7) or a combination.

The cathode current collector 108 can be, as a non-limiting example, an aluminum sheet or foil, carbon paper or graphene paper.

The composite cathode layer 102 is illustrated in FIG. 1. The composite cathode layer 102 has cathode active material particles 120. The cathode active material can include one or more lithium transition metal oxides and lithium transition metal phosphates. Lithium transition metal oxides and lithium transition metal phosphates can include, but are not limited to, LiCoO₂, LiNiO₂, LiNi_{0.8}Co_{0.15}Al_{0.05}O₂, LiMnO₂, Li(Ni_{0.5}Mn_{0.5})O₂, LiNiₓMn_{y}Co_{z}O₂, wherein 0.40≤x≥0.90, 0.0≤y≥0.50, and 0.0≤z≥0.60 and x+y+z=1, such as LiNi_{0.85}Mn_{0.1}Co_{0.5}O₂, spinel Li₂Mn₂O₄, LiFePO₄ and other polyanion compounds, and other olivine structures including LiMnPO₄, LiCoPO₄, LiNi_{0.5}Co_{0.5}PO₄, and LiMn_{0.33}Fe_{0.33}Co_{0.33}PO₄.

The optimal lithium halide material that is used to coat the cathode active material particles is found to be one that has a potential window (V) of between 0.5 and 4.3, have an ion conductivity of between 1.0 mS/cm and 3.0 mS/cm, and has a Young's Modulus of between 26 Gpa and 34 Gpa. The lithium halide material 122 is one or more selected from the group consisting of: Li₃GaF₆, Li₃InCl₆, Li₃InBr₆, Li₃ScI₆, Li₂ScₓIn_{2/3-x}Cl₄ (0.17<x<0.50), Li₃YCl₆, Li₃YBr₆, Li₃YClₓBr₆₋ₓ(1.2<x<4.8), Li₃Y₁₋ₓInₓCl₆ (0<x<1), Li₃HoCl₆, Li₃HoBr₆, Li₃₋ₓM₁₋ₓZr^{x}Cl₆ (M=Y, Er, Yb, and Fe, 0<x<1), Li₃YbCl₆, Li₃YbBr₆, Li₃₋ₓYb₁₋ₓHfₓCl₆ (0<x<1), Li₃ErBr₆, and Li₃ErI₆. The lithium halide material 122 is between 5.0 wt % and 10.0 wt % of the composite cathode layer.

The optimal lithium sulfide material will have high ionic conductivity (e.g., greater than 4.5 mS/cm) and a similar Young's Modulus (e.g., 22 Gpa-33 Gpa). The lithium sulfide material 124 is one or more selected from the group consisting of: Li₆PS₅Cl, Li₆PS₅Br, Li₆PS₅I, Li₆PSsClₓBr₁₋ₓ (0.2<x<0.8), Li₇₋ₓPS₆₋ₓClₓ (x=1.1-1.9), and Li₇₋ₓPS₆₋ₓBrₓ (x=1.0-1.7). The lithium sulfide material 124 is between 5.0 wt % and 10.0 wt % of the composite cathode layer.

To coat the lithium halide material 122 onto the cathode active material particles 120, mechanical mixing is required. The lithium halide material 122 is provided as particles with a D50 diameter between 1 μm and 3 μm, while the cathode active material particles 120 are provided with a D50 diameter of 5 μm to 9 μm, as non-limiting examples. Thermal treatment may improve the performance of the coated material depending on the materials used, with a typical temperature range being about 50° C. to 150° C. Thermal treatment may be under vacuum, depending on the materials.

The coated cathode active material particles and then mixed with the lithium sulfide material 124 and optionally one or both of carbon 126 to increase electronic conductivity and a dry binder 128, such as polytetrafluoroethylene (PTFE). No solvent is used. It is contemplated that the composite cathode layer 102 consists of the cathode active material 120, the lithium halide material 122 and the lithium sulfide material 124, with the carbon 126 and dry binder 128 are used as needed.

A test ASSB cell was made using LiNi_{0.85}Mn_{0.1}Co_{0.5}O₂ as the cathode active material particles 120, Li₃YClₓBr₆₋ₓ (1.2<x<4.8) as the lithium halide material 122, Li₆PSsClₓBr₁₋ₓ (0.2<x<0.8) as the lithium sulfide material 124. The cathode active material 120 was 80 wt % of the composite cathode layer 104, while the amounts of the lithium halide material 122 and the lithium sulfide material 124 was varied as shown in Table 1. Carbon 126 was used at 2.9 wt % and PTFE was used at 1.4 wt % to produce a dry composite cathode layer having a thickness ranging between 95 μm and 105 μm. The separator 104 was Li₆PSsClₓBr₁₋ₓ (0.2<x<0.8) at a thickness of 600 μm. The anode 106 was indium doped lithium metal. The cell was cycled from 1.9 to 3.7 V, c/10 at 60° C.

Table 1 below compares different amounts of the lithium halide material 122 and the lithium sulfide material 124, as well as if and how the lithium halide material 122 and the cathode active material 120 was heat treated and mixed. Manual mixing is equivalent to using a mortar and pestal.

TABLE 1

| | | | | Halide | Heating | Charging | Discharging | Efficiency |
|---|---|---|---|---|---|---|---|---|
| Li₃YClₓBr₆₋ₓ | | Li₆PS₅ClₓBr₁₋ₓ | | Mixing | Treatment | mAh/g | mAh/g | (1st) % |
| 15.7 | wt % (C) | 0.0 | wt % | Manual | No | 233.4 | 182.4 | 78.1 |
| 8.0 | wt % | 7.7 | wt % | Manual | No | 388.6 | 103.1 | 26.5 |
| 8.0 | wt % | 7.7 | wt % | Manual | 180° C. | 204.2 | 137.0 | 67.1 |
| 5.0 | wt % | 10.7 | wt % | Mechanical | No | 232.6 | 177.4 | 76.3 |
| 5.0 | wt % | 10.7 | wt % | Mechanical | 100° C. | 234.1 | 192.8 | 82.3 |
| 8.0 | wt % | 7.7 | wt % | Mechanical | No | 234.5 | 189.6 | 80.9 |
| 8.0 | wt % | 7.7 | wt % | Mechanical | 180° C. | 217.9 | 188.7 | 86.6 |
| 8.0 | wt % (A) | 7.7 | wt % | Mechanical | 100° C. | 232.2 | 203.7 | 87.7 |
| 8.0 | wt % (B) | 7.7 | wt % | Mechanical | 100° C. | 231.2 | 196.3 | 84.9 |
| 0.0 | wt % (D) | 15.7 | wt % | | No | 233.5 | 170.8 | 73.2 |

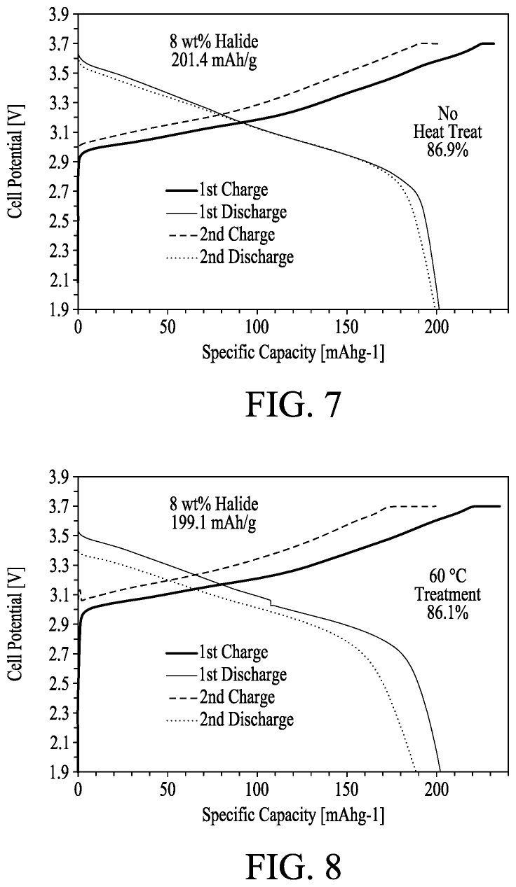

The following is clear from the data in Table 1. The lithium halide material and the cathode active material particles should be mechanically mixed to achieve the best performance. With the particular materials used in this example, heat treatment produced better results. However, the results started to degrade somewhat at 180° C., indicating the temperature may be too high, being detrimental to the materials. The combination of the lithium halide material with the lithium sulfide material clearly provides better performance over either material alone. FIGS. 3-6 show the charge-discharge curves for A-D, respectively, in Table 1, above.

A second test ASSB cell was made using LiNi_{0.85}Mn_{0.1}Co_{0.5}O₂ as the cathode active material particles 120, Li₂ScₓIn_{2/3-x}Cl₄ (0.17<x<0.50) as the lithium halide material 122, Li₆PS₅ClₓBr₁₋ₓ (0<x<1) as the lithium sulfide material 124. The cathode active material 120 was 80 wt % of the composite cathode layer 104, while the amounts of the lithium halide material 122 and the lithium sulfide material 124 was varied as shown in Table 1. Carbon 126 was used at 2.9 wt % and PTFE was used at 1.4 wt % to produce a dry composite cathode layer having a thickness ranging between 95 μm and 105 μm. The separator 104 was Li₆PS₅ClₓBr₁₋ₓ (0<x<1) at a thickness of 600 μm. The anode 106 was indium doped lithium metal. The cell was cycled from 1.9 to 3.7 V, c/10 at 60° C.

Table 2 below compares different amounts of the lithium halide material 122 and the lithium sulfide material 124, as well as if and how the lithium halide material 122 and the cathode active material 120 was heat treated and mixed.

| | | | | Halide | Heating | Charging | Discharging | Efficiency |
|---|---|---|---|---|---|---|---|---|
| Li₂ScₓIn_{2/3-x}Cl₄ | | Li₆PS₅ClₓBr₁₋ₓ | | Mixing | Treatment | mAh/g | mAh/g | (1st) % |
| 15.7 | wt % (C) | 0.0 | wt % | Manual | No | 216.2 | 171.8 | 79.5 |
| 8.0 | wt % (A) | 7.7 | wt % | Mechanical | No | 231.6 | 201.4 | 86.9 |
| 8.0 | wt % (B) | 7.7 | wt % | Mechanical | 60° C. | 231.1 | 199.1 | 86.1 |
| 0.0 | wt % (D) | 15.7 | wt % | | No | 233.5 | 170.8 | 73.2 |

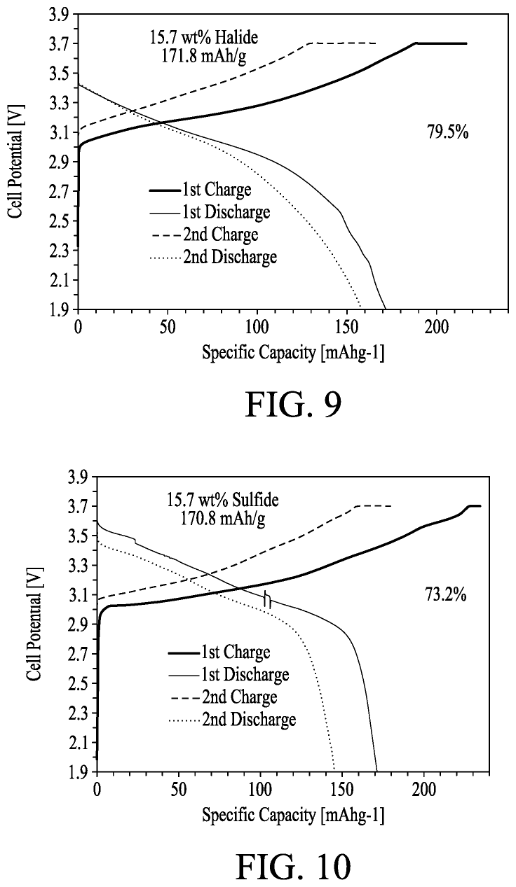

The following is clear from the data in Table 2. The lithium halide material and the cathode active material particles should be mechanically mixed to achieve the best performance. With the particular materials used in this example, no heat treatment produced better results. However, heat treatment at lower temperatures also produced good results. The combination of the lithium halide material with the lithium sulfide material clearly provides better performance over either material alone. FIGS. 7-10 show the charge-discharge curves for A-D, respectively, in Table 2, above.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

1. An all-solid-state battery cell, comprising:
a lithium metal anode;
a cathode current collector;
a composite cathode layer comprising:
active cathode material particles coated in a lithium halide material; and
a lithium sulfide material embedding coated active cathode material particles; and
a separator between the composite cathode layer and the lithium metal anode.

2. The all-solid-state battery cell of claim 1, wherein the lithium halide material is one or more selected from the group consisting of: Li₃GaF₆, Li₃InCl₆, Li₃InBr₆, Li₃ScI₆, Li₂ScₓIn_{2/3-x}Cl₄ (0.17<x<0.50), Li₃YCl₆, Li₃YBr₆, Li₃YClₓBr₆₋ₓ (1.2<x<4.8), Li₃Y₁₋ₓInₓCl₆ (0<x<1), Li₃HoCl₆, Li₃HoBr₆, Li₃₋ₓM₁₋ₓZr^{x}Cl₆ (M=Y, Er, Yb, and Fe, 0<x<1), Li₃YbCl₆, Li₃YbBr₆, Li₃₋ₓYb₁₋ₓHfₓCl₆ (0<x<1), Li₃ErBr₆, and Li₃ErI₆.

3. The all-solid-state battery cell of claim 1, wherein the lithium sulfide material is one or more selected from the group consisting of: Li₆PS₅Cl, Li₆PS₅Br, Li₆PS₅I, Li₆PS₅ClₓBr₁₋ₓ (0.2<x<0.8), Li₇₋ₓPS₆₋ₓClₓ (x=1.1-1.9), and Li₇₋ₓPS₆₋ₓBrₓ (x=1.0-1.7).

4. The all-solid-state battery cell of claim 1, wherein the lithium halide material is between 5.0 wt % and 10.0 wt % of the composite cathode layer.

5. The all-solid-state battery cell of claim 1, wherein the lithium sulfide material is between 5.0 wt % and 10.0 wt % of the composite cathode layer.

6. The all-solid-state battery cell of claim 1, wherein the lithium halide material is Li₃YClₓBr₆₋ₓ (1.2<x<4.8) and the lithium sulfide material is Li₆PS₅ClₓBr₁₋ₓ (0.2<x<0.8).

7. The all-solid-state battery cell of claim 1, wherein the lithium halide material is Li₂ScₓIn_{2/3-x}Cl₄ (0.17<x<0.50) and the lithium sulfide material is Li₆PS₅ClₓBr₁₋ₓ (0.2<x<0.8).

8. The all-solid-state battery cell of claim 7, wherein the separator is Li₆PS₅ClₓBr₁₋ₓ (0.2<x<0.8).

9. The all-solid-state battery cell of claim 1, wherein the cathode active material particles are LiNiₓMn_{y}Co_{z}O₂, wherein 0.40≤x≥0.9, 0.0≤y≥0.50, and 0.0≤z≥0.60 and x+y+z=1.

10. The all-solid-state battery cell of claim 9, wherein the cathode active material particles are LiNi_{0.85}Mn_{0.1}Co_{0.05}O₂.

11. The all-solid-state battery cell of claim 1, wherein the separator is one or a combination of Li₆PS₅Cl, Li₆PS₅Br, Li₆PS₅I, Li₆PS₅ClₓBr₁₋ₓ (0.2<x<0.8), Li₇₋ₓPS₆₋ₓClₓ (x=1.1-1.9), or Li₇₋ₓPS₆₋ₓBrₓ (x=1.0-1.7).

12. A composite cathode layer for an all-solid-state battery cell, consisting, in use, of:
active cathode material particles;
a lithium halide material coated onto the active cathode material particles;
a lithium sulfide material embedding coated active cathode material particles; and
optionally, one or both of carbon and dry binder interspersed throughout the lithium sulfide material.

13. An all-solid-state battery cell, comprising:
a lithium metal anode;
a cathode current collector;
a composite cathode layer consisting of, in use:
active cathode material particles;
a lithium halide material coated onto the active cathode material particles;
a lithium sulfide material embedding coated active cathode material particles; and
optionally, one or both of carbon and dry binder interspersed throughout the lithium sulfide material; and
a separator between the composite cathode layer and the lithium metal anode.

14. The all-solid-state battery cell of claim 13, wherein the lithium halide material is one or more selected from the group consisting of: Li₃GaF₆, Li₃InCl₆, Li₃InBr₆, Li₃ScI₆, Li₂ScₓIn_{2/3-x}Cl₄ (0.17<x<0.50), Li₃YCl₆, Li₃YBr₆, Li₃YClₓBr₆₋ₓ(1.2<x<4.8), Li₃Y₁₋ₓInₓCl₆ (0<x<1), Li₃HoCl₆, Li₃HoBr₆, Li₃₋ₓM₁₋ₓZr^{x}Cl₆ (M=Y, Er, Yb, and Fe, 0<x<1), Li₃YbCl₆, Li₃YbBr₆, Li₃₋ₓYb₁₋ₓHfₓCl₆ (0<x<1), Li₃ErBr₆, and Li₃ErI₆.

15. The all-solid-state battery cell of claim 13 wherein the lithium sulfide material is one or more selected from the group consisting of: Li₆PS₅Cl, Li₆PS₅Br, Li₆PS₅I, Li₆PS₅ClₓBr₁₋ₓ (0.2<x<0.8), Li₇₋ₓPS₆₋ₓClₓ (x=1.1-1.9), and Li₇₋ₓPS₆₋ₓBrₓ (x=1.0-1.7).

16. The all-solid-state battery cell of claim 13, wherein the lithium halide material is between 5.0 wt % and 10.0 wt % of the composite cathode layer.

17. The all-solid-state battery cell of claim 13, wherein the lithium sulfide material is between 5.0 wt % and 10.0 wt % of the composite cathode layer.

18. The all-solid-state battery cell of claim 13, wherein the lithium halide material is Li₃YClₓBr₆₋ₓ (1.2<x<4.8) and the lithium sulfide material is Li₆PS₅ClₓBr₁₋ₓ (0.2<x<0.8).

19. The all-solid-state battery cell of claim 13, wherein the lithium halide material is Li₂ScₓIn_{2/3-x}Cl₄ (0.17<x<0.50) and the lithium sulfide material is Li₆PS₅ClₓBr₁₋ₓ (0.2<x<0.8).

20. The all-solid-state battery cell of claim 13, wherein the separator is one or a combination of Li₆PS₅Cl, Li₆PS₅Br, Li₆PS₅I, Li₆PS₅ClₓBr₁₋ₓ (0.2<x<0.8), Li₇₋ₓPS₆₋ₓClₓ (x=1.1-1.9), or Li₇₋ₓPS₆₋ₓBrₓ (x=1.0-1.7).
